(19) United States
(12) Patent Application Publication
(10) Pub. No.: US 2015/0223445 A1
(43) Pub. Date: Aug. 13, 2015

(54) Silhouette Decoy With Three-Dimensional Head

(71) Applicant: Albert Stephen Falkenstein, Norton, OH (US)

(72) Inventor: Albert Stephen Falkenstein, Norton, OH (US)

(21) Appl. No.: 14/180,069

(22) Filed: Feb. 13, 2014

(51) Int. Cl. A01M 31/06

(52) U.S. Cl. CPC A01M 31/06

(57) ABSTRACT

An animal decoy consists of a two-dimensional silhouette body and a three-dimensional head, the two replicating a desired animal, such as a waterfowl or the like. The two-dimensional body portion has front and back sheets separated by corrugations defining elongated channels. A three-dimensional head, being the more important portion of a decoy, has a wire or rod extending therefrom for insertion into an elongated channel for a friction fit at any of a multitude of selectable or desired orientations. The body is formed of a corrugated paperboard or plastic sheet material, while the head is preferably molded of a rigid foam material.

### TECHNICAL FIELD

The invention herein resides in the art of decoys of the type used to replicate an animal. Particularly, the invention relates to decoys of the type that can be readily transported and put into place at a desired location, whether for attracting or repelling other animals. Specifically, the invention relates to an animal decoy having a substantially planar or two-dimensional body and a positionable and removable three-dimensional head, giving the decoy an enhanced lifelike appearance.

### BACKGROUND ART

Decoys of animals are commonly used for various purposes. The decoy of a predator can be used to frighten away or repel unwanted animals. For example, the decoy of an owl can be used to repel pigeons or other birds from rooftops, and the decoy of a fox or coyote can be used to repel rabbits and woodchucks from garden areas.

Commonly, decoys are used by hunters and the like to attract animals of a similar nature. Decoys have been commonly used to attract waterfowl, such as ducks and geese, with those decoys having most typically been of a full, three-dimensional nature, either molded of plastic or carved of wood. Recently, two-dimensional decoys have been employed, the same giving the appearance, at a distance, of a live animal. However, detection of the deceit being practiced often occurs when the live animal is drawn into close proximity to the two-dimensional decoy.

While the three-dimensional decoys have typically been effective in drawing birds or animals of like kind to them, they are both expensive to acquire and maintain and cumbersome to transport and place in the field, marsh, or the like. Two-dimensional decoys, while not as effective as the three-dimensional ones, have the attractive feature of being less costly and easier to transport and place in large volumes.

There is a need in the art for an animal decoy that possesses the benefits of both the two-dimensional and three-dimensional decoys previously known.

### DISCLOSURE OF INVENTION

In light of the foregoing, it is a first aspect of the invention to provide a decoy having the benefits of ease of transportation and placement, while also having the benefits of more accurately replicating the appearance of a live animal.

Other aspects of the invention are the provision of an animal decoy that has the primary benefit of giving a three-dimensional view to an otherwise two-dimensional silhouette, further enhancing a lifelike appearance.

Still a further aspect of the invention is the provision of an animal decoy, which is adjustable in the field, particularly allowing the head of the decoy to assume various positions relative to the body or base of the decoy.

Yet another aspect of the invention is the provision of an animal decoy in which the head of the decoy, most prominently observed by other animals, is fully three-dimensional, while the remainder of the decoy is of a silhouette nature.

The foregoing and other aspects of the invention that will become apparent as the detailed description proceeds are achieved by an animal decoy, comprising: a two-dimensional base replicating a silhouette of a body of an animal; and a three-dimensional head replicating a head of said animal received by said base.

### DESCRIPTION OF DRAWINGS

For an appreciation of the various aspects and structures of the invention, reference should be made to the following detailed description and accompanying drawings, wherein:

FIG. 1 is a side-elevational view of a two-dimensional decoy base used with an embodiment of the invention;

FIG. 2 is a top plan view of the base of FIG. 1 showing the corrugated nature thereof;

FIG. 3 is a side-elevational view of a three-dimensional molded head assembly used with an embodiment of the invention;

FIG. 4 is a front-elevational view of the head assembly of FIG. 3;

FIG. 5 is a bottom-elevational view of the head of FIG. 4;

FIG. 6 is a side-elevational assembly drawing of an animal decoy made in accordance with the invention; and

FIG. 7 is a side-elevational view of a decoy positioned for use.

### DETAILED DESCRIPTION OF PREFERRED EMBODIMENT

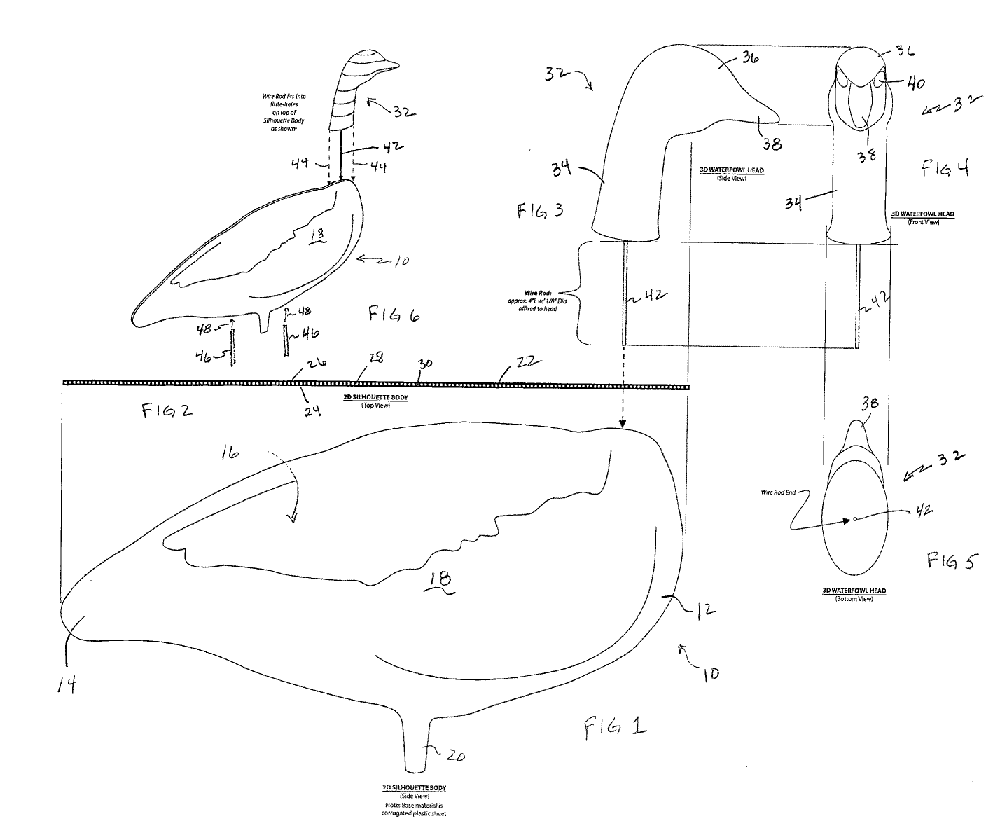

Referring now to the drawings and more particularly FIG. 1, it can be seen that a two-dimensional decoy base employed with an embodiment of the invention is designated generally by the numeral 10. As will become apparent herein, the decoy of the invention is shown and described in the context of a waterfowl, and more particularly a Canada goose, while it will be appreciated that similar decoys for any of various birds or mammals may be employed. The decoy base 10 includes a breast section 12, a tail section 14, wing section 16, and body section 18. A truncated leg section 20 depends from a lower edge thereof. It will be appreciated that the decoy base 10 provides the silhouette of the goose or other animal, rather than a three-dimensional replication thereof.

The thickness of the base portion 10 is apparent from reference to FIG. 2 where it can be seen that the silhouette two-dimensional decoy base 10 is constructed of a corrugated material 22. According to a preferred embodiment of the invention, the corrugated material 22 has a thickness on the order of 0.10-0.40 inch. The corrugated material 22 consists of a front sheet 24 and a back sheet 26 sandwiching corrugations, ribs or spacers 28 therebetween. The corrugations, ribs or spacers define elongated channels 30, as shown.

It will be appreciated that the front and back sheets 24, 26 are printed with the appearance of the decoy animal or fowl, such as the Canada goose under consideration. The corrugated material 22 may be of a paperboard construction, preferably waxed for protection from the environment, or may be of a corrugated plastic sheet construction. In any event, the decoy base 10 is substantially two-dimensional, having a minimal thickness, and providing the silhouette of the body of the animal replicated thereby.

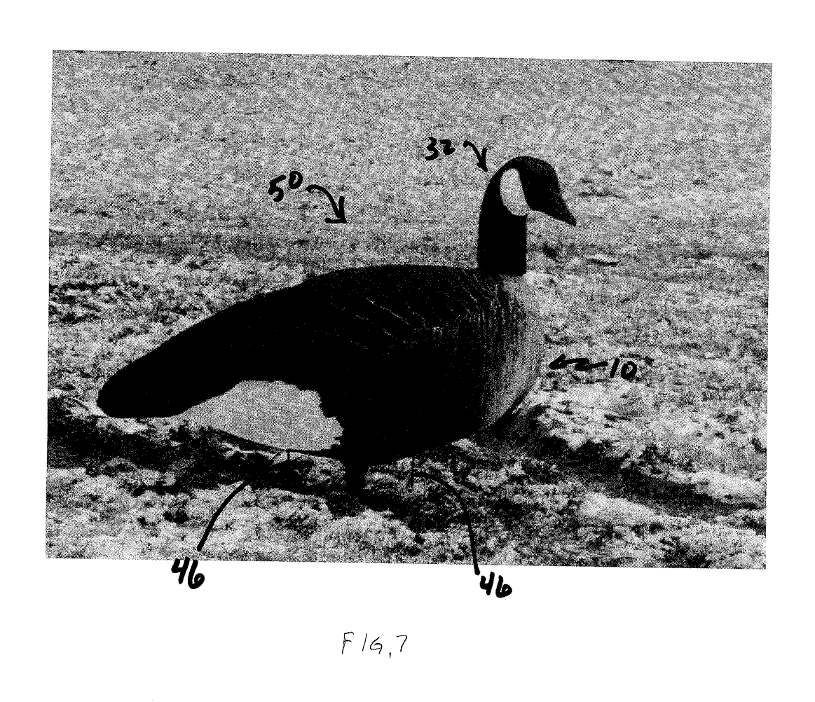

Applicant believes that the most remarkable portion of an animal is its head and eyes, which are most notably observed by other animals. Accordingly, applicant believes that the focal point of the decoy, the head of the replicated animal, should be as lifelike as possible. To that end, as shown in FIGS. 3-5, a three-dimensional head and neck assembly 32 is provided. As shown, a three-dimensional neck 34 extends to a three-dimensional head 36 having thereon a beak 38 and eyes 40. The colors and markings are such as to enhance the accurate replication of the animal, here a Canada goose.

According to a preferred embodiment of the invention, the head and neck assembly 32 is molded of a rigid foam and has molded therein and extending therefrom a wire or rod 42.

As shown in FIG. 6, the wire or rod 42 that is fixed to the molded head and neck assembly 32 is placed into an elongated channel 30 of the corrugations separating the front and back sheets 24, 26 of the decoy base. The head and neck assembly 32 nests against the body section 18 in any of various orientations, as selected by the user, to provide the most lifelike appearance among the decoys employed. The wire or rod 42 engages the walls of the elongated channels 30 by a friction fit, accommodating various orientations and adjustments thereof. The friction fit is of sufficient strength to preclude the head and neck assembly 32 from inadvertently moving from blowing winds or the like.

As further shown in FIG. 6, the head and neck assembly 32 is attached to the body portion 18 by movement of the wire or rod 42 in the direction of the arrows 44. In similar fashion, base wires or rods 46 are provided for insertion into the corrugation channels 30 along the lower edge of the two-dimensional decoy base 10 by insertion in the direction of the arrows 48. With the wires or rods 46 so inserted, they may then be pushed into the soil or ground in a field, marsh, water edge or the like to serve as the desired decoy.

With reference now to FIG. 7, an appreciation can be had of the final appearance of the silhouette decoy with a three-dimensional head designated generally by the numeral 50 and as assembled from the pieces and parts identified in FIGS. 1-6. As shown in FIG. 7, the base wires or rods 46 are inserted into the ground and the head and neck assembly 32 is angled at any desired angle with respect to the two-dimensional decoy base 10 to best replicate a live animal.

Thus, it can be seen that the various aspects of the invention have been achieved by the structure presented and described above. While in accordance with the patent statutes, only the best known and preferred embodiment of the invention has been presented and described in detail, the invention is not limited thereto or thereby. Accordingly, for an appreciation of the true scope and breadth of the invention, reference should be made to the following claims.

What is claimed is:

1. An animal decoy, comprising:
a two-dimensional base replicating a silhouette of a body of an animal; and
a three-dimensional head replicating a head of said animal received by said base.

2. The animal decoy as recited in claim 1, wherein said head is removable from and adjustably positionable with respect to said two-dimensional base.

3. The animal decoy as recited in claim 2, wherein said base is formed from a pair of front and back sheets separated by ribs or spacers.

4. The animal decoy as recited in claim 3, wherein said ribs or spacers define channels therebetween.

5. The animal decoy as recited in claim 4, wherein said head is received by said base by a rod extending from said head and received in one of said channels.

6. The animal decoy as recited in claim 5, wherein said rod is received by said channel by a friction fit.

7. The animal decoy as recited in claim 5, further comprising at least one base rod received by said base at an edge thereof and extending therefrom for placement into a ground area for positioning of the animal decoy.

8. The animal decoy as recited in claim 5, wherein said head is molded of rigid foam.

9. The animal decoy as recited in claim 8, wherein said rod extending from said head is molded into said head.

10. The animal decoy as recited in claim 9, wherein said base is of a wax-coated, corrugated, paperboard construction.

11. The animal decoy as recited in claim 9, wherein said base is of a corrugated plastic sheet construction.

12. The animal decoy as recited in claim 8, wherein said body and head replicate those of a fowl.
